(19) United States
(12) Patent Application Publication
(10) Pub. No.: US 2011/0161345 A1
(43) Pub. Date: Jun. 30, 2011

(54) SYSTEM AND METHOD FOR RETRIEVAL OF INFORMATION CONTAINED IN SLIDE KITS

(75) Inventors: Ross E. Dworkin, Springfield, PA (US); Charles A. Bono, Gwynedd Valley, PA (US)

(73) Assignee: BLUE GROTTO TECHNOLOGIES, INC., Plymouth Meeting, PA (US)

(21) Appl. No.: 12/649,564

(22) Filed: Dec. 30, 2009

(51) Int. Cl. G06F 3/01; G06F 17/30

(52) U.S. Cl. 707/769; 715/730; 707/E17.014

(57) ABSTRACT

A slide kit contains slides having citations. The slides are loaded into memory, and the citations are automatically parsed. The system automatically connects to external databases to obtain and download texts associated with the citations, so that the user can review the slides together with such texts. The system also allows the user to select slides from a list of citations, so as to determine which slides contain a particular citation. In another embodiment, the system enables the user to define a search which is executed among the texts associated with citations contained in the slide kit. Thus, in general, the result of the search may include slides which may or may not themselves contain the search terms. In this way, the user may retrieve slides based on their general relevance, without regard to the specific words shown on the slides.

### BACKGROUND OF THE INVENTION

This invention relates to the field of information management, and provides a system and method for retrieving information contained in slide kits used in educational presentations or in other fields.

Slides are frequently used in the delivery of oral presentations in academic environments, in business, and in other fields. The term “slide” originally referred to a translucent photographic film that would move (“slide”) into position in a projector, for viewing on a screen. Modern technology has largely replaced the old photographic slide by a computer-generated image that is projected onto a screen.

Modern “slides” are typically created by known software programs, such as PowerPoint (the term PowerPoint is a trademark of the Microsoft Corporation, of Redmond, Wash.). The images created by these programs are still called “slides”, for convenience of description, even though they may not be photographic, and may not physically “slide” through anything.

In this specification, the term “slide” is used in its most general meaning, to include both conventional photographic slides, as well as computer-generated images. Indeed, in this specification, the term can refer to any display of information, whether the display is static or moving (such as a video), provided that the display can be handled as a unit, and placed in a series containing other similar or dissimilar units.

Examples of systems and methods which facilitate the creation and editing of slide kits are given in U.S. Patent Application Pub. No. 2006-0218004 A1, U.S. Patent Application Pub. No. 2006-0236246 A1, and U.S. Patent Application Pub. No. 2008-0028314. The disclosures of all of the above-cited published applications are incorporated by reference herein.

The present invention is intended to solve the problem of retrieving information contained in, or referenced by, slide kits, as described below.

A company typically has several “core” slide kits, for use in creating sales presentations. Some slide kits might contain general company information. Other kits might contain general information about the products of the company. Still other kits might contain specific information about products with respect to particular markets.

If the company is large, there may be several different kinds of representatives using the slide kits. For example, there could be sales representatives, or there could be research scientists, etc. In a large company, there might be several dozen, or more, representatives for each category. As these representatives give presentations, they create modified versions of the slide kits. Because of the large number of individuals involved, a large number of versions of slide kits are soon created. For example, one could start with ten “core” slide kits, and these could shortly become fifty or more kits.

When storing and categorizing slide kits, it is helpful to be able to identify slides and update them based on citations contained in such slides.

Specifically, it is desirable to be able to search for slides, in a slide kit, based on the content of the articles or abstracts referenced by the slides, and to be notified when newer articles refer to articles referenced by the slides.

The present invention provides a system and method for organizing citations contained in slide kits, and for using such citations for searches and for alerting the user of new developments.

The present invention solves the above problems by providing a system that creates a list of citations contained in a slide kit, subjects the citations to manual review, and automatically acquires the content referenced by these citations. The material so obtained is then used when searching for slides, and can be used to alert the user to the existence of new material which may be relevant to a given slide.

The present invention has two major parts. The first part processes slides and parses the citations contained therein, at the time that the slides are uploaded into the system. The second part allows searching among abstracts or articles that are referenced by slides in the slide kit. The invention therefore substantially enhances the ability of a user to retrieve information contained in, or indirectly referenced by, slides in a slide kit.

### SUMMARY OF THE INVENTION

In one embodiment, the present invention comprises the method of retrieving information relating to a slide kit, the method including loading one or more slides into memory, automatically parsing each citation, contained in the slides, to extract bibliographic information about the citation, and automatically connecting to an external database containing a text (such as an abstract or a full text) corresponding to the citation, and downloading such text. The process is performed, in general, for a plurality of citations. The system presents the citations to the user, in a standardized format, and gives the user the opportunity to make corrections.

After having downloaded the texts described above, the system can present, to the user, a display comprising a slide together with a text corresponding to one of the citations shown on that slide. That is, the user can view a slide, and, by navigating among the citations listed on the slide, can also view a text (either an abstract or a full text) corresponding to each citation.

In another embodiment, the invention includes the method of loading a plurality of slides into memory, extracting citations from the slides to as to create a list of all citations contained within the set of slides, and displaying the list of citations to the user. The user may then select any of the citations, and the system can retrieve all slides, from the given set, which slides contain the selected citations.

In still another embodiment, the invention comprises the method of loading slides into memory, establishing a database containing texts corresponding to each citation contained in the slides, accepting from the user a search request comprising one or more words to be searched, executing the search among such texts in the database, and displaying, to the user, the slides which contain citations associated with text that satisfies the search request. Thus, the slides retrieved in the search may not, in general, contain the words for which the user searched, because such search is not performed in the texts contained in the slides themselves, but rather in the texts associated with citations contained in the slides.

The present invention also includes a system for practicing the above-described method. The system includes a central computer, linked by the Internet, or by other means, to one or more users, and also linked, such as by the Internet, to a plurality of external databases containing texts associated with citations contained in a set of slides.

The present invention therefore has the primary object of providing a system and method for retrieving information associated with slides of a slide kit.

The invention has the further object of facilitating the processing and review of citations contained within a slide kit.

The invention has the further object of enabling a user to examine slides, of a slide kit, according to the citations contained on the respective slides.

The invention has the further object of providing a list of all citations contained within a slide kit, for further analysis by a user.

The invention has the further object of enabling a user to search for pertinent terms among texts associated with citations contained in a slide kit, without regard to the specific words which may be contained within the slides of the slide kit.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a diagram showing a typical display screen of the slide management system of the present invention.

FIG. 2 provides a flow chart showing the process of generating a database of abstracts and/or articles, relating to citations contained in a slide kit, according to the present invention.

FIG. 3 shows the display screen which illustrates the step of uploading of a slide kit into the system of the present invention.

FIG. 4 shows a display screen which is presented to the user after the system of the present invention has parsed the citations contained on the slides of a slide kit.

FIG. 5 provides a flow chart showing more details concerning block

of FIG. 2, relating to the retrieval of abstracts or articles by the system of the present invention.

FIG. 6 provides a diagram representing a database, maintained by the system of the present invention, containing various abstracts corresponding to citations in slides in a slide kit.

FIG. 7 provides a diagram representing a database, used by the system of the present invention, to download texts referenced by citations in a slide.

FIG. 8 shows a screen display, generated by the system of the present invention, showing a slide associated with an abstract of an article cited in that slide.

FIG. 9 shows a screen display, generated by the system of the present invention, allowing the user to search for slides based on citations contained in the slides, or based on content of abstracts or articles referenced by a slide.

FIG. 10 shows a screen display, generated by the system of the present invention, showing citations contained in a slide kit, and allowing the user to select certain slides, or view abstracts, associated with such citations.

FIG. 11 shows a screen display, generated by the system of the present invention, showing a slide retrieved, based on a citation contained therein.

FIG. 12 shows a screen display, generated by the system of the present invention, showing a search interface which allows the user to retrieve slides based on words or phrases contained in articles cited in such slides.

FIG. 13 shows a screen display, generated by the system of the present invention, resulting from the search indicated in FIG. 12.

FIG. 14 provides a block diagram of the system of the present invention.

### DETAILED DESCRIPTION OF THE INVENTION

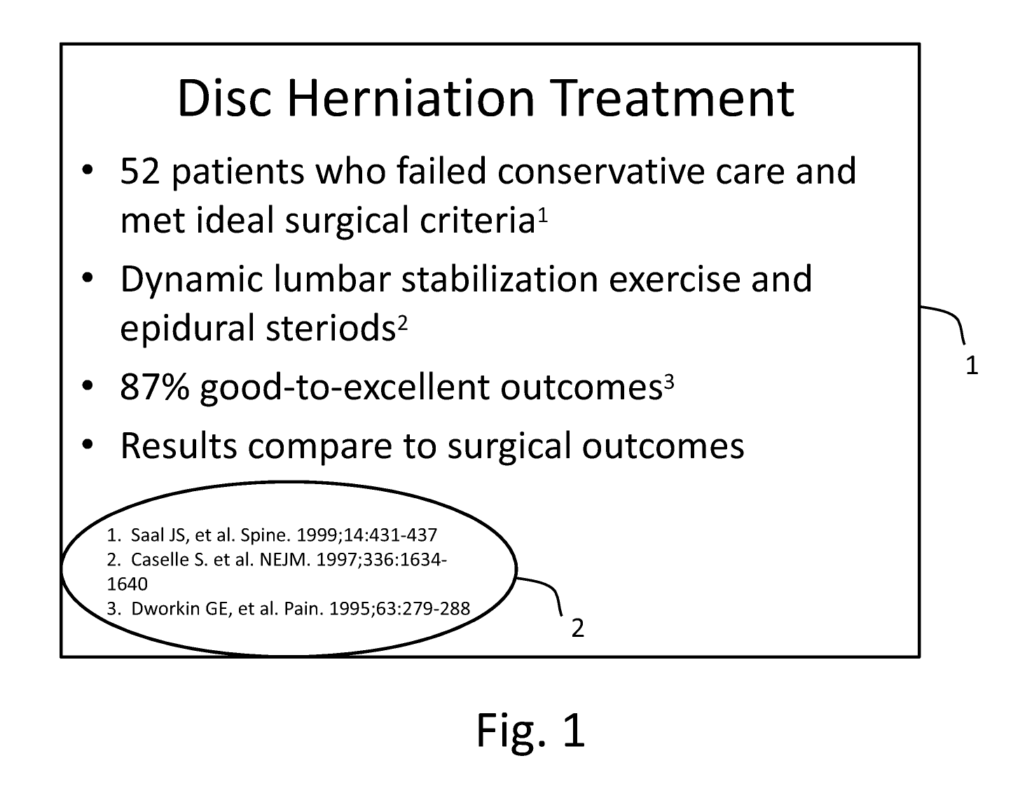

FIG. 1 illustrates a typical slide which is processed by the present invention. The slide contains text, identified generally by reference numeral 1. In this particular example, the text occupies the majority of the area of the slide. In general, the text could occupy a different proportion of the area of the slide. Also, in general, the slide might contain other objects such as graphs, pictures, etc.

At the bottom of the slide appear several citations 2, encircled for emphasis. The citations provide references to pertinent journal articles. The citations may be in any of several standardized formats. The system of the present invention is programmed to recognize various known standardized formats, so that it can automatically parse the information in the citations. By “parsing” it is meant that the system automatically extracts pertinent bibliographical information from the citations (such as title, author, volume and page, year of publication, etc.) so that such information can be used later.

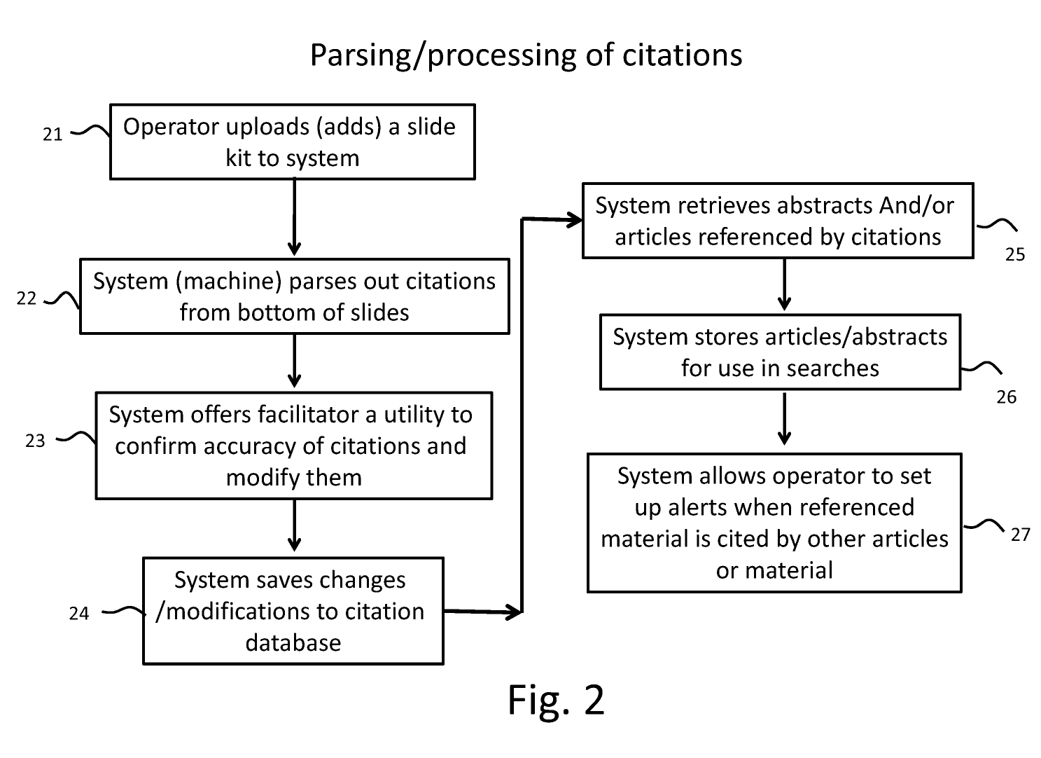

FIG. 2 provides a flow chart showing the process by which the system of the present invention assembles a database of abstracts and/or articles corresponding to citations contained in slides of a slide kit.

In block 21, the user uploads (or adds) a slide kit to the system. In block 22, the system parses the citations found at the bottom of the slides. As a result of the parsing step, the system presents, to the user, information on the supposed structure of the citations. For example, for a given citation, the system displays several blocks, labeled “author”, “title”, “volume”, “page”, etc., and presents data in each block. The parsing process represents the best “guess” of the system as to the structure of the citation.

The system presents, to the user, information on the hypothesized structure of the citations, in block 23, and gives the user the opportunity to make changes. The “guess” made by the system is based on stored known formats for citations. If a particular citation does not fit a standard format, the results of the parsing will likely be wrong, but the user has ample opportunity to make corrections.

As part of the process described in FIG. 2, the system compiles a database of citations extracted from the slides in the slide kit. This database may simply contain a series of records, each record being identified by a number, and containing the basic information comprising a citation. If the user needs to make corrections, such corrections are saved and stored in this citation database, in block 24.

After the database of citations has been compiled, the system then automatically retrieves, or attempts to retrieve, the abstracts or full texts of the articles identified by each citation. This step is symbolized by block 25. In a preparatory step (not illustrated in FIG. 2), the system is provided with data enabling the system to make online contact with the publishers of each article, so as to download the full text of the article or of its abstract. In general, the system may need a user identification and password, pertaining to a particular publisher, and all such data is assumed to be stored in memory by the present system.

Thus, having a list of citations, each citation identifying a particular journal, the system can automatically query one or more external databases to download the article, or abstract, pertaining to each citation.

As used herein, the term “external” means that the database is not part of the present system, but is a database maintained by another party. If such downloading is successful, the articles or abstracts are stored in a system database, as indicated in block 26.

In general, such attempts to download may not always be successful, in which case the system can be programmed to try again later. In a preferred embodiment, the system is programmed to query the external databases automatically and periodically, to attempt to download all articles or abstracts corresponding to citations contained in the slides.

The system also allows the user to establish alerts when particular material is cited by other articles, as indicated in block 27. In general, the system is programmed to query periodically one or more databases, to determine whether newer articles have appeared, which cite a given reference. The system can then alert the user when such newer articles have been published. The latter periodic queries can be in addition to the periodic queries discussed earlier.

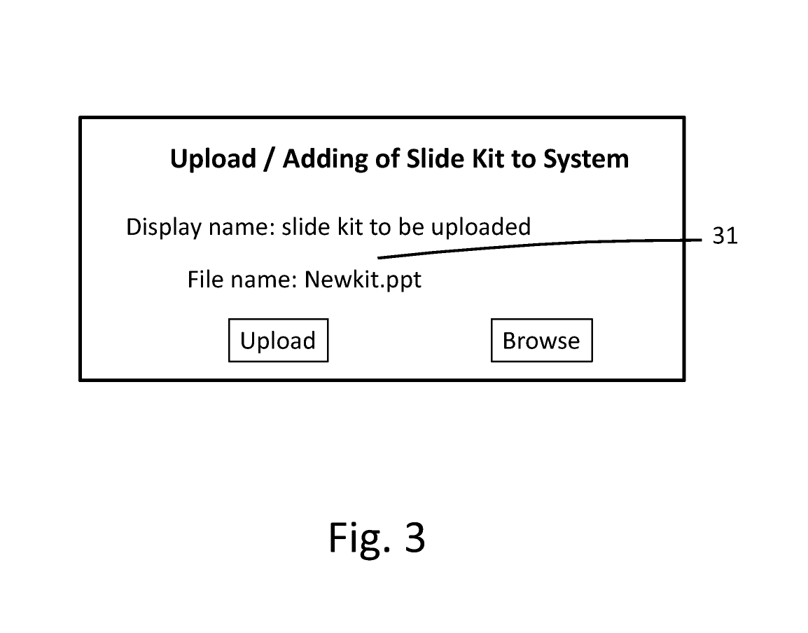

FIGS. 3-7 further illustrate the process represented by the flow chart of FIG. 2.

FIG. 3 shows a display screen wherein the user first uploads a slide kit into the system. The uploading is performed by entering pertinent information in a pop-up window or block 31. As indicated in the figure, the user types the title and/or file name of the slide kit (which has been previously stored), so that such kit can be uploaded into active memory.

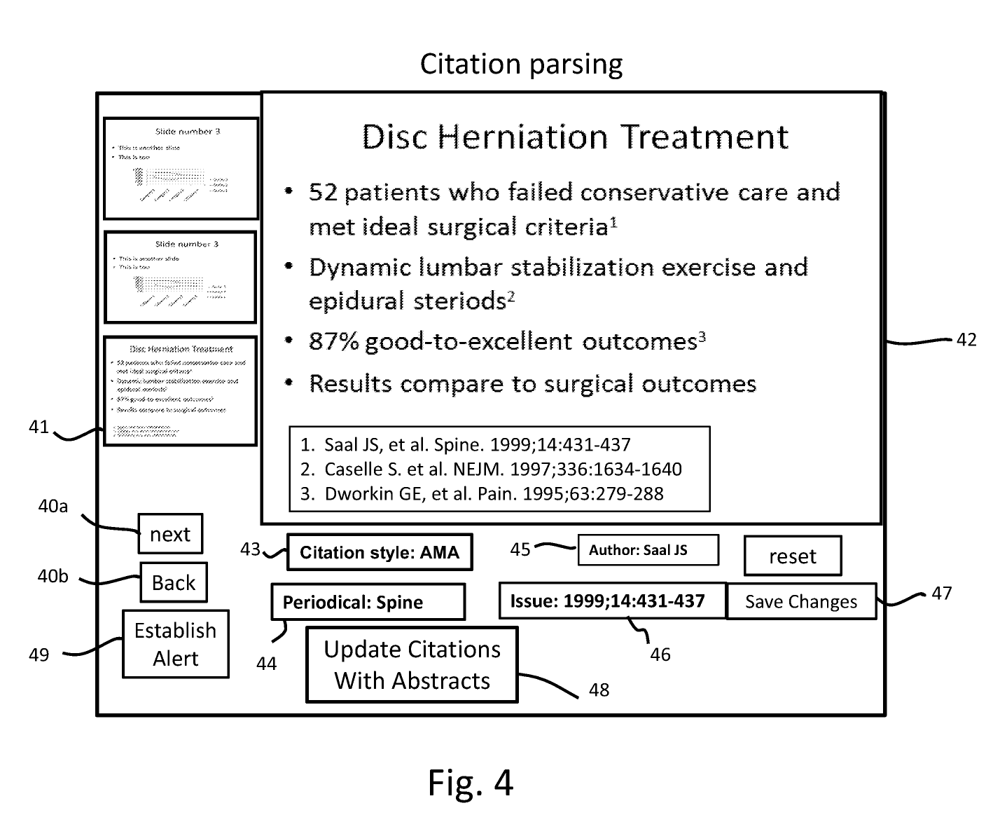

FIG. 4 shows a typical display which is generated after the system has attempted to parse the citation information contained in the slides. The left-hand column 41 shows three slides in miniature or “thumbnail” display. These slides represent the slides of the kit; in the more general case, there will be many more such thumbnails. When the user clicks on a particular thumbnail, the system displays the selected item in full on the screen. In the example given, slide 42 corresponds to the third thumbnail of column 41.

FIG. 4 contains four blocks, identified by reference numerals 43-46, which represent the results of the parsing. Block 43 indicates the citation style. The system makes a “guess” of the style, based on the content of the citation. Block 44 indicates the name of the periodical. Block 45 indicates the name of the author. Block 46 provides data on the volume number, year of publication, and page references. Thus, the parsing operation results in the presentation of a citation in a box display format which facilitates the entry of corrections.

In some cases, such as where the citation style is non-standard, the information shown in the blocks 43-46 may be unintelligible, in which case the user has the opportunity to enter new information in these blocks.

After the user has made changes in any of blocks 43-46, the user clicks the button 47, which causes the changes to be saved to the database of citations.

By clicking button 48, the user causes the system to log on to an appropriate database containing the abstract or full text of the citation referenced in blocks 43-46. In this way, the user manually forces the system to attempt to find the pertinent abstract or article. Note that, in general, an abstract or article may be missing from the system database either because the citation was not correctly parsed, or because of some communications problem in downloading the information. Button 48 enables the user to force the system to seek the desired information again.

Block 49 enables the user to set up alerts pertaining to the citation illustrated in blocks 43-46. That is, block 49 enables the feature represented by block 27 of FIG. 2. When such an alert is enabled, the system is programmed to query the pertinent database, periodically, to search for newer articles which reference the citation shown in blocks 43-36. If such articles are found, the user can be notified automatically.

The “next” and “back” buttons 40a and 40b are used to navigate among the various citations contained on the selected slide. In the example shown, the selected slide contains three citations. The first of these citations is currently shown in blocks 43-46. Clicking on the “next” button 40a causes the second citation to be shown in blocks 43-46. To change the slide shown in the main display, one clicks on the appropriate thumbnail in column 41.

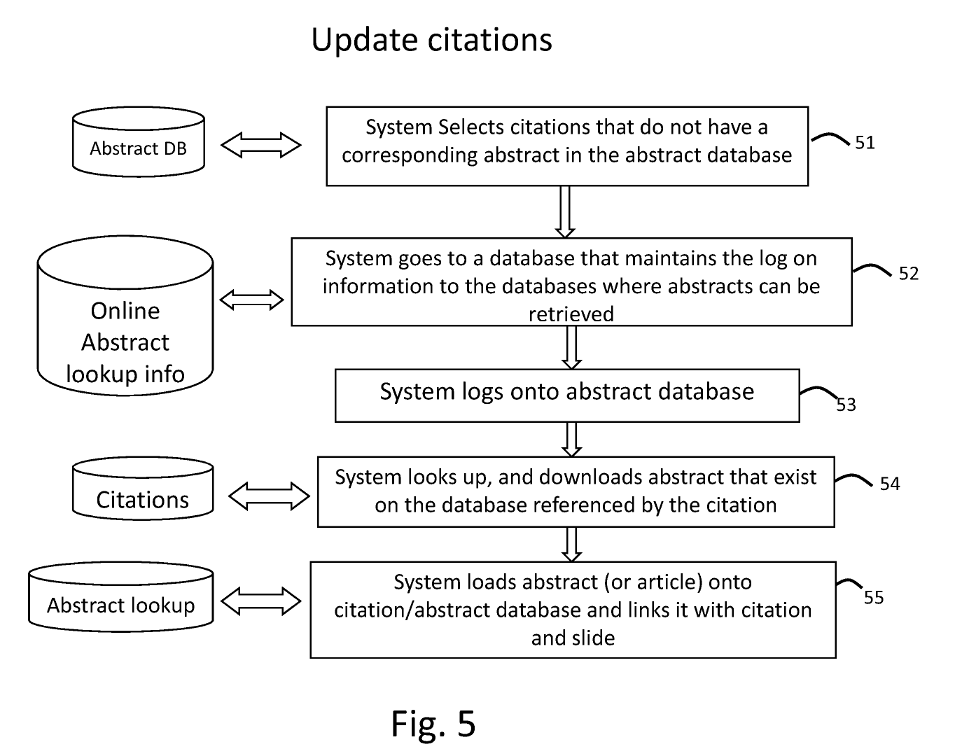

FIG. 5 provides a flow chart illustrating, in more detail, the process represented by block 25 of FIG. 2. In block 51, the system selects the citations that do not have a corresponding abstract in the abstract database maintained by the system. When the system is first started, it may be that none of the abstracts has been retrieved. In general, the database maintained by the system will have abstracts or articles for some, but not all, of the citations contained in the slides of the slide kit.

In block 52, the system retrieves information from an internal file containing log-on information for databases where the desired abstracts can be located. The system then logs onto these databases automatically, in block 53. The system then downloads the abstract (or full article) pertaining to the citation of interest, in block 54. This abstract or article is then loaded into the database maintained by the system, in block 55. The system also links the abstract or article with the corresponding citation and slide.

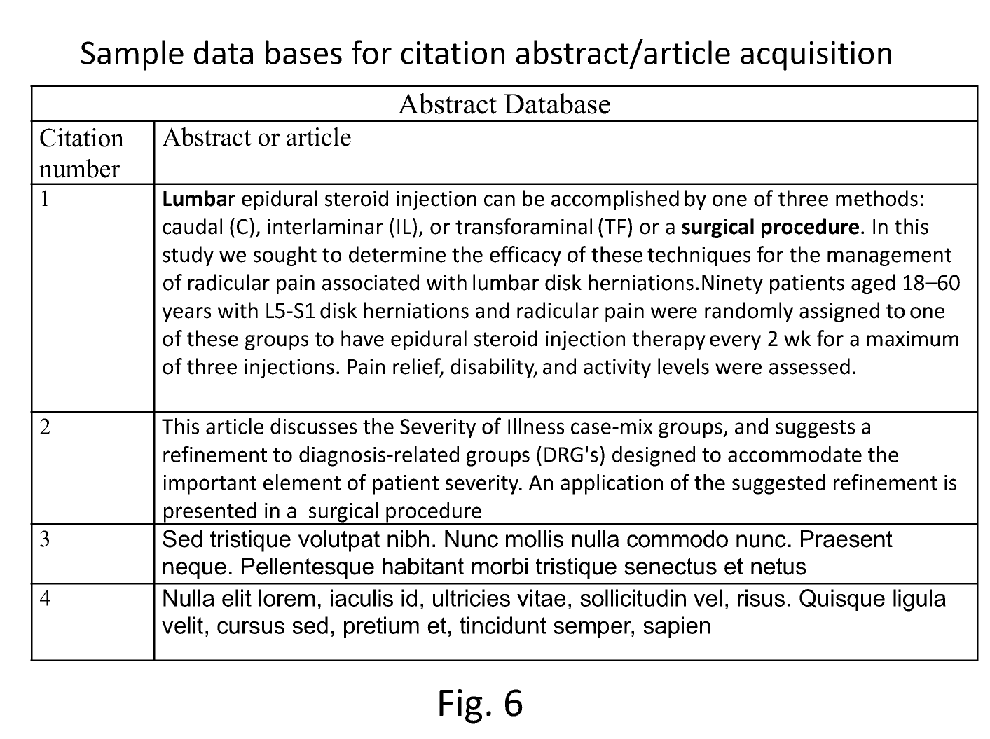

FIG. 6 provides a hypothetical example of a database, maintained by the system of the present invention, containing the abstracts or articles associated with the citations contained in the slide kit. Each abstract or article is associated with a citation number, which enables the system to link the abstract or article to the correct citation.

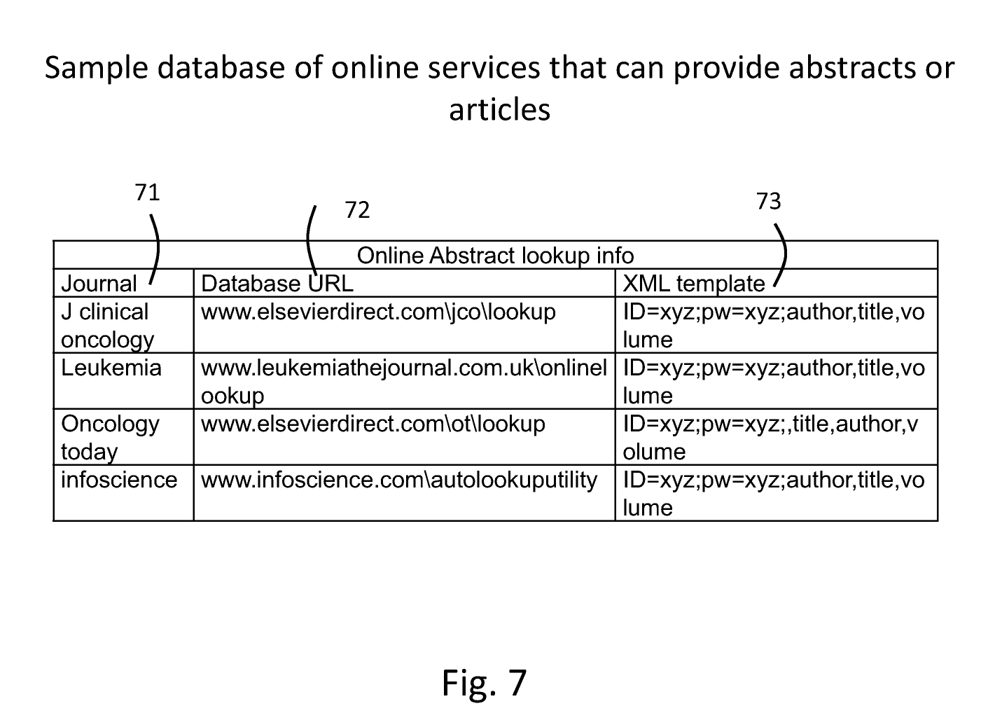

FIG. 7 provides a hypothetical example of the database, maintained by the system of the present invention, showing the log-in information needed for the various external databases containing articles or abstracts of interest. The first column 71 contains the name of each journal. The second column 72 provides the URL of the publisher, or other source from which the text can be retrieved. The third column 73 provides identification information used to access the corresponding external database, together with a template showing the format of citations used for queries of that database. In general, the database illustrated in FIG. 7 provides all information needed by the system to make an automatic inquiry of an external database, and to download an abstract or article associated with a given citation.

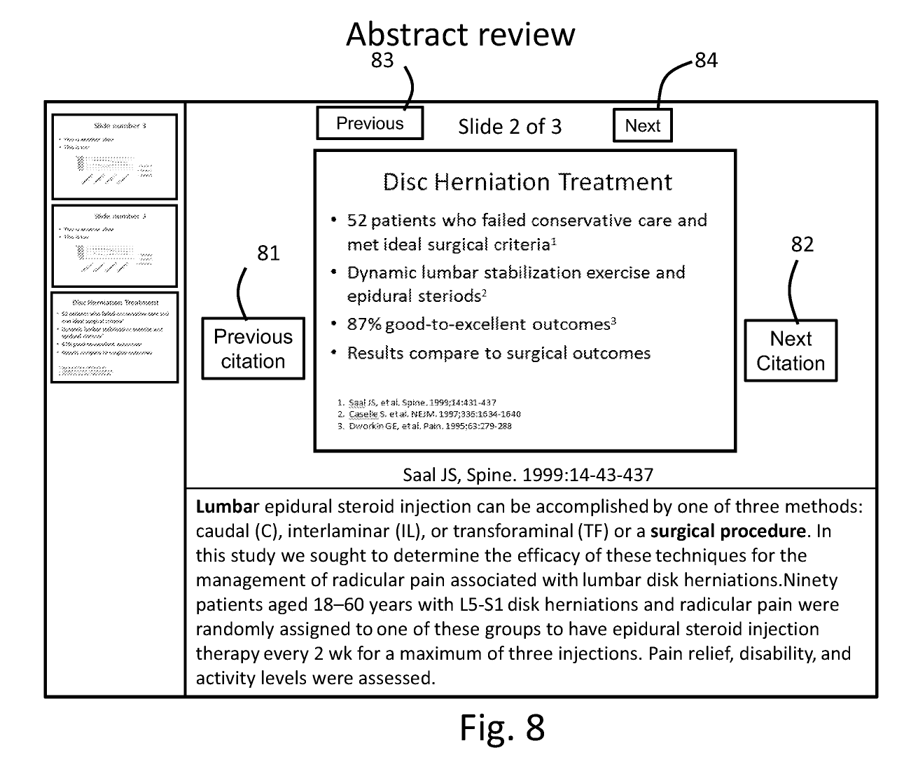

FIG. 8 provides a sample screen display, generated by the system of the present invention, showing a slide, together with the abstract (or article) pertaining to a citation appearing on that slide. As before, the column on the left-hand side provides thumbnail versions of the slides in the kit. The user clicks on one of such thumbnails, and the selected slide appears in the main display. In the example shown, the user has clicked on the third slide in the left-hand column.

The citation displayed below the slide is one of the citations appearing on the slide. The text below the citation is the full text of the abstract associated with the citation. Alternatively, the text could be the full text of the article.

The user can navigate among citations by using the buttons 81 and 82. When the user clicks on one of these buttons, the citation presented below the slide changes, and the text displayed below the citation also changes, such that the text corresponds to the citation.

The user can also navigate among slides in the kit by using the buttons 83 and 84.

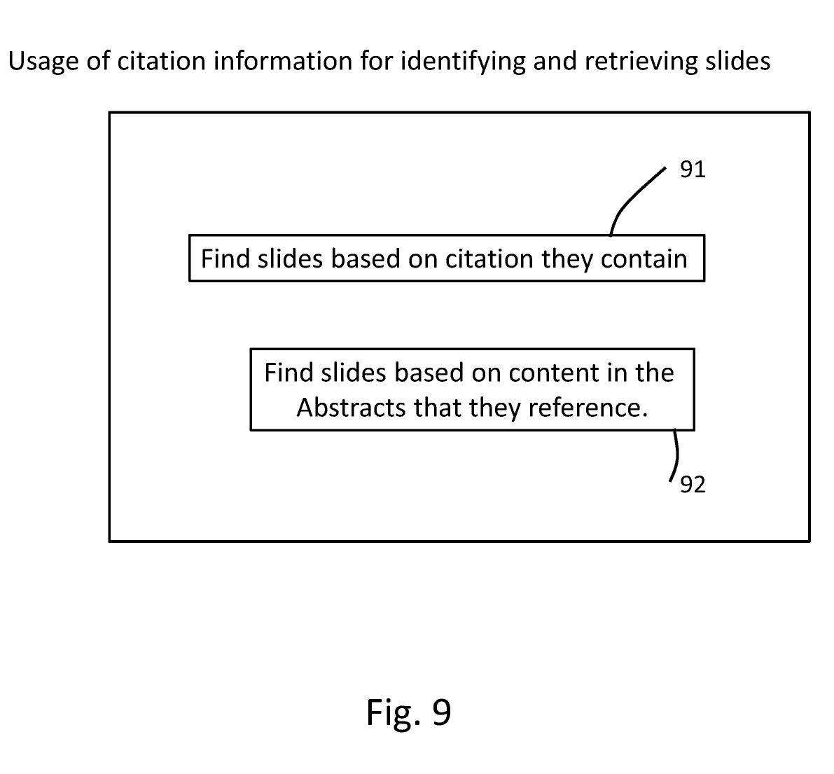

FIGS. 9-13 illustrate the procedure for searching based on citations or on content contained within cited references.

FIG. 9 shows a display screen, generated by the system of the present invention, enabling the user to perform the desired search. Button 91 initiates a search for slides based on the citation they contain, and button 92 initiates a search for slides based on words found in the abstracts or articles referenced in the slide.

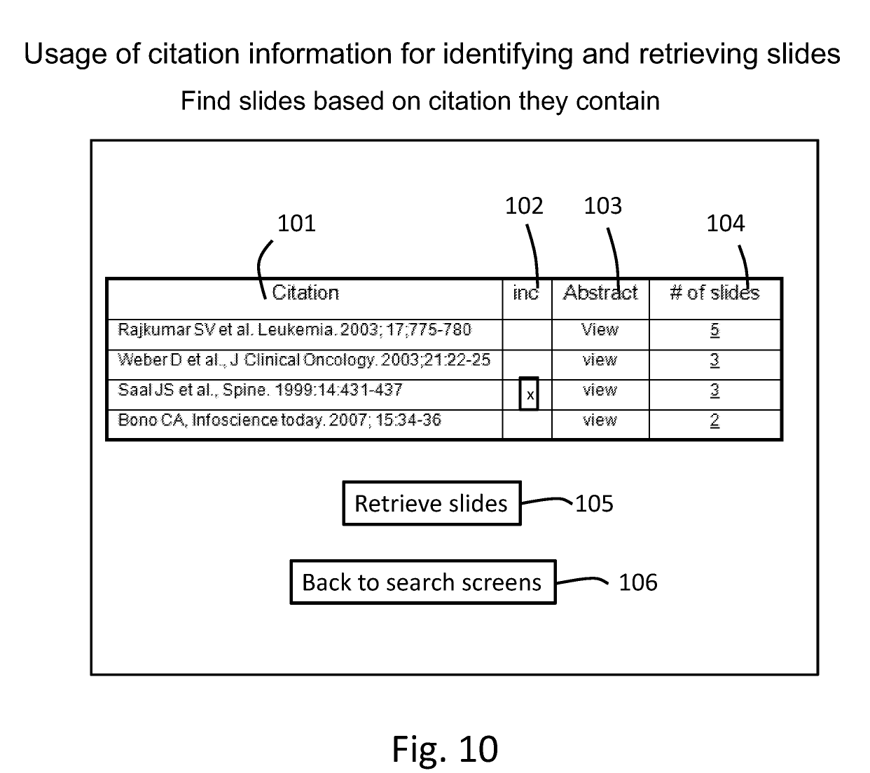

Suppose, first, that the user clicks button 91 in FIG. 9. The user is then presented with a display exemplified by FIG. 10. The left-hand column, identified by reference numeral 101, lists all citations contained in any slide in the slide kit. The right-hand column, identified by reference numeral 104, indicates the number of slides which contain the corresponding citation. If the user clicks on one of the numbers in the right-hand column 104, the system presents the user with the pertinent set of slides, preferably in a format similar to that used in FIG. 8.

The column identified by reference numeral 103 indicates to the user whether an abstract (or full text article) is available for viewing. In general, abstracts or full text articles may not be available for all of the citations, for various reasons, as mentioned above.

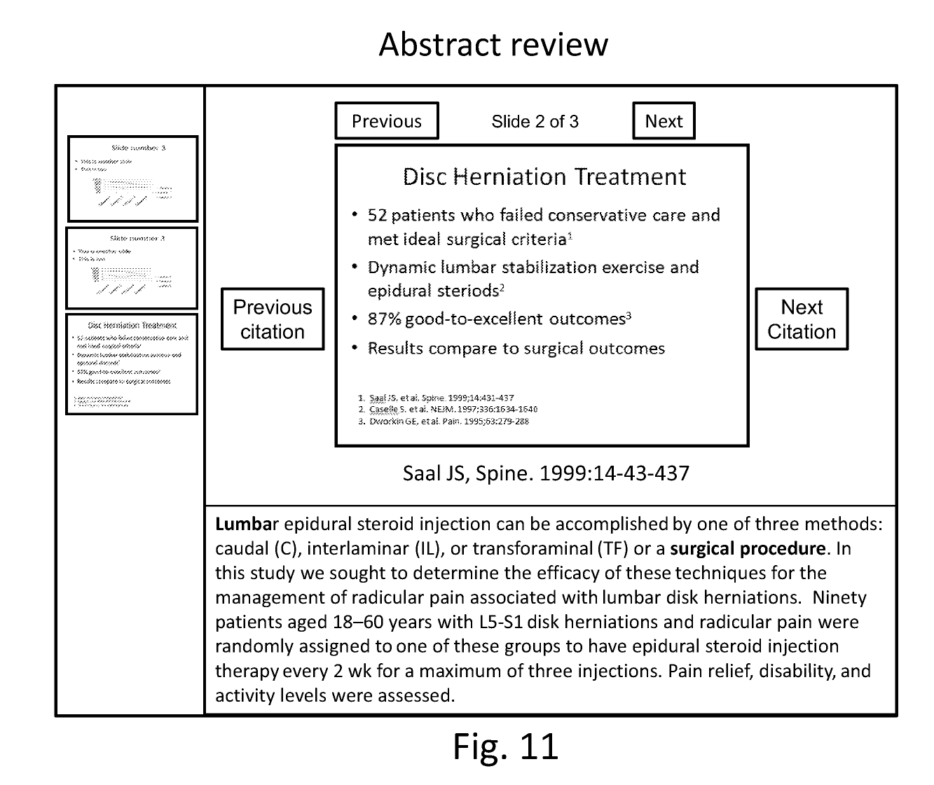

The column identified by reference numeral 102 enables the user to insert check marks to select a combination of citations. After the user checks the desired boxes, to indicate the citations of interest, the user then clicks button 105, which retrieves all slides which contain any of the checked citations. The result is exemplified by FIG. 11, which has the same format as FIG. 8. That is, the user is presented with a set of slides, shown in thumbnail form on the left-hand side. The selected slide is displayed in the main portion of the screen, together with one of its citations and the corresponding text of the abstract (or full article) below the citation. Button 106 of FIG. 10 allows the user to return to the basic search screen of FIG. 9.

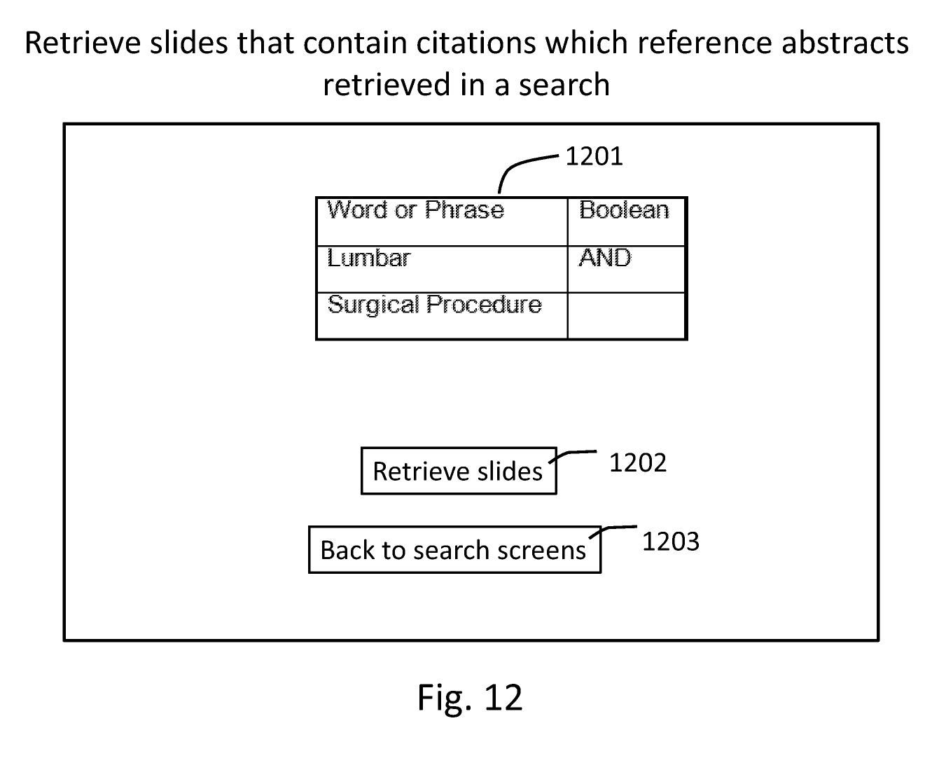

Now suppose that the user clicks button 92 in FIG. 9. The next screen display is shown in FIG. 12. Block 1201 allows the user to type words or phrases, and Boolean operators, to define a search. In the example given, the user is searching for documents containing both “lumbar” and “surgical procedure”.

However, it is important to emphasize that this search is not conducted among slides of the slide kit, but rather is conducted among abstracts or full-text articles referenced by the slides in the kit. In general, words appearing in those abstracts or articles might not appear in the slides themselves. Thus, the search indicated in FIG. 12 is not a search through the uploaded slide kit, but instead is a search through text that is distinct from that of the slide kit. However, the result of the search comprises slides which reference articles in which the indicated search terms appear.

The search indicated by block 1201 is initiated by clicking on button 1202. The user may return to the basic search screen (FIG. 9) by clicking button 1203.

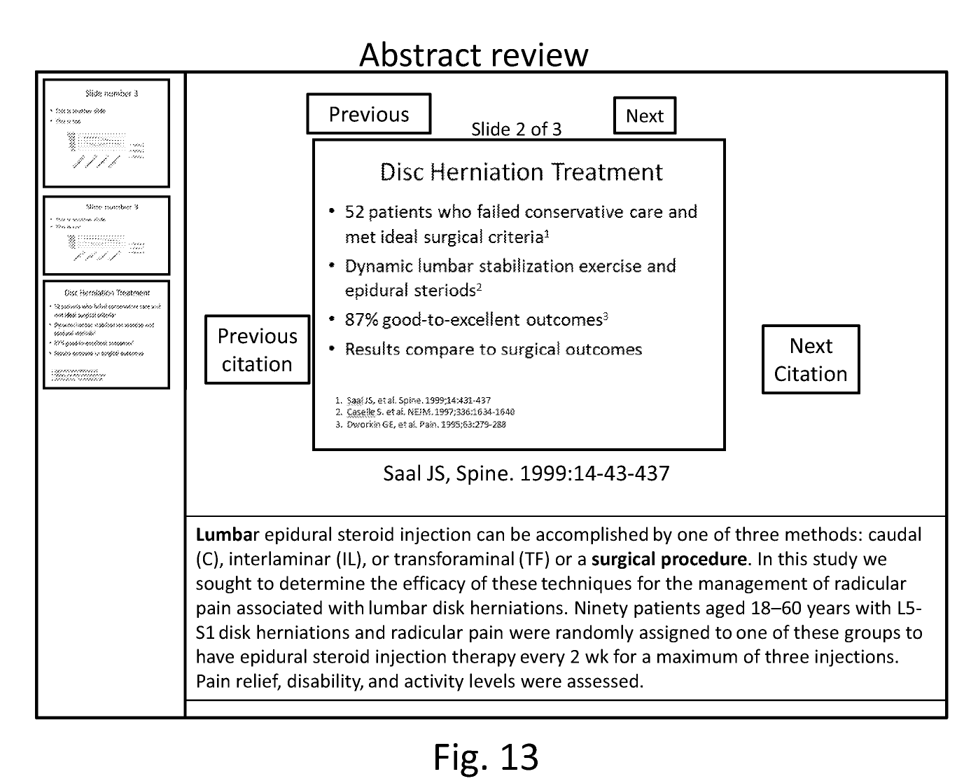

FIG. 13 represents the result of the search indicated in FIG. 12. The figure shows one of the retrieved slides, with an abstract corresponding to one of the citations referenced in the slide. The words “lumbar” and “surgical procedure” both appear in the abstract, as required by the search illustrated in FIG. 12. Note, however, that this exact combination of words does not appear in the slide itself. In general, the combination may or may not appear in the slide itself; the search is conducted among the abstracts or articles referenced by the slides, but not in the texts of the actual slides.

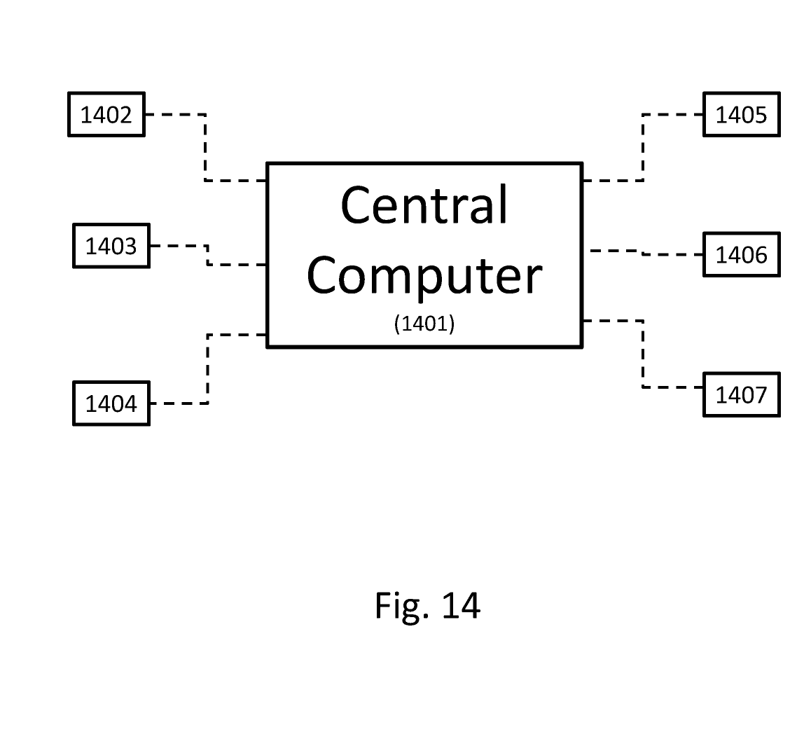

FIG. 14 provides a block diagram of the system of the present invention, including external elements. The heart of the invention is central computer 1401. The computer 1401 is connected, preferably by an Internet connection, or equivalent, to a plurality of users, identified by reference numerals 1402-1404. The computer 1401 is also connected, preferably by an Internet connection, to external databases 1405-1407. Although the central computer is shown at a location different from those of the users and the databases, in the most general case, the computer could be located at the same place as any of the afore-mentioned entities.

For operation of the system, the connection between the users and the central computer should be continuous or frequent. The connection between the central computer and the external databases may be more sporadic, as the computer will usually query the database only on a limited basis. In the most general case, the connection could be continuous, however.

The central computer performs all of the functions described above. In particular, the computer comprises means for loading slides into memory. It comprises means for extracting and parsing citations contained in the slides, and for establishing connections with the external databases, and for downloading texts from such databases. The computer includes a memory, and comprises means for storing downloaded text in the memory, and for internally linking the downloaded texts to their corresponding citations.

The central computer, together with the computers operated by the users 1402-04 also comprise the means for displaying results to the user. Such results may include sets of slides, with or without additional information, such as texts of abstracts or articles referenced in the slide being displayed.

The computer also comprises means for displaying parsed citations, and for enabling the user to correct the parsed citations. The computer also comprises the means for enabling the user to navigate among citations, and to select slides for display, as described above.

The memory of the computer 1401 comprises means for storing a database containing texts, such as abstracts or full articles, associated with citations in the slide kit.

The computer is also programmed with a search interface, so that the computer comprises the means for accepting a search request from the user, and for executing the search among the desired texts.

The invention can be modified in various ways. The specific design of the search screens can be changed. The algorithms used for parsing the information contained in the slides can be varied. The arrangement of the components of the system can be altered. These and other modifications, which will be apparent to those skilled in the art, should be considered within the spirit and scope of the following claims.

What is claimed is:

1. A method for retrieving information relating to a slide kit, comprising:
a) loading at least one slide into a memory, wherein at least one slide loaded into memory contains a plurality of citations,
b) automatically parsing each citation to extract bibliographic information about the citation,
c) providing information taken from each citation in a display format which facilitates entry of corrections, and enabling the user to navigate among various citations, such that the information in said display format changes in response to citations selected by the user,
d) automatically establishing a connection with an external database, said external database containing a text corresponding to said citation, and downloading said text, and
e) displaying said text corresponding to a selected citation on a same screen as the slide.

2. The method of claim 1, wherein step (d) further comprises storing said text in memory, and linking said text to a corresponding citation.

3. The method of claim 1, wherein said text is selected to be from the group consisting of abstracts and full articles, relating to said citation.

4. A method for retrieving information relating to a slide kit, comprising:
a) loading at least one slide into a memory, wherein said at least one slide includes at least one citation of a reference,
b) establishing a database containing a text corresponding to each citation,
c) accepting, from a user, a search request, the search request comprising at least one word to be searched,
d) executing the search request among texts contained within the database established in step (b), and
e) displaying, to the user, slides which contain citations associated with text which satisfies the search request.

5. The method of claim 4, wherein step (b) is performed by automatically downloading said text from an external database containing texts associated with said citation.

6. The method of claim 4, wherein step (e) includes displaying at least one slide which does not itself contain words which satisfy the search request.

7. A method for retrieving information relating to a slide kit, comprising:
a) loading a plurality of slides into a memory, wherein said slides include at least one citation of a reference,
b) establishing a database containing a text corresponding to each citation,
c) accepting, from a user, a search request, the search request comprising at least one word to be searched,
d) executing the search request among texts contained within the database established in step (b), and
e) displaying, to the user, slides which contain citations associated with text which satisfies the search request,
wherein the text includes at least one word which does not appear on the slide, and wherein step (e) includes displaying at least one slide which does not itself contain words which satisfy the search request.

8. A system for retrieving information relating to a slide kit, comprising:
a) means for loading at least one slide into a memory, wherein at least one slide loaded into memory contains a plurality of citations,
b) means for automatically parsing each citation to extract bibliographic information about the citation,
c) means for providing information taken from each citation in a display format which facilitates entry of corrections, and for enabling the user to navigate among various citations, such that the information in said display format changes in response to citations selected by the user,
d) means for automatically establishing a connection with an external database, said external database containing a text corresponding to said citation, and for downloading said text, and
e) means for displaying said text corresponding to a selected citation on a same screen as the slide.

9. The system of claim 8, wherein the connection establishing means includes means for storing said text in memory, and for linking said text to a corresponding citation.

10. A system for retrieving information relating to a slide kit, comprising:
a) means for loading at least one slide into a memory, wherein said at least one slide includes at least one citation of a reference,
b) means for establishing a database containing a text corresponding to each citation,
c) means for accepting, from a user, a search request, the search request comprising at least one word to be searched,
d) means for executing the search request among texts contained within the database established by the establishing means, and
e) means for displaying, to the user, slides which contain citations associated with text which satisfies the search request.

11. The system of claim 10, wherein the system displays, to the user, at least one slide which does not itself contain words which satisfy the search request.

12. A system for retrieving information relating to a slide kit, comprising:
a) means for loading a plurality of slides into a memory, wherein said slides include at least one citation of a reference,
b) means for establishing a database containing a text corresponding to each citation,
c) means for accepting, from a user, a search request, the search request comprising at least one word to be searched,
d) means for executing the search request among texts contained within the database established by the establishing means, and
e) means for displaying, to the user, slides which contain citations associated with text which satisfies the search request,
wherein the text includes at least one word which does not appear on the slide, and wherein the system displays, to the user, at least one slide which does not itself contain words which satisfy the search request.
